(19) United States
(12) Patent Application Publication
(10) Pub. No.: US 2021/0409135 A1
(43) Pub. Date: Dec. 30, 2021

(54) METHOD AND APPARATUS FOR DETERMINING THE EFFICIENCY OF PUBLICITY AND/OR BROADCASTED PROGRAMS

(71) Applicant: O.Z. 89 Ltd., Tel Aviv (IL)

(72) Inventors: Ofer LEVI, Rehovot (IL); Zvi SHALOM, Beer Sheva (IL)

(73) Assignee: O.Z. 89 Ltd., Tel Aviv (IL)

(21) Appl. No.: 16/476,454

(22) PCT Filed: Jan. 8, 2018
(86) PCT No.: PCT/IL2018/050027

§ 371 Date: Jul. 8, 2019

(30) Foreign Application Priority Data
Jan. 8, 2017 (IL) 249978

(51) Int. Cl. H04H 60/31; H04H 60/58; H04H 60/66

(52) U.S. Cl. CPC H04H 60/31; H04H 60/58; H04H 60/51; H04H 2201/90; H04H 60/66

(57) ABSTRACT

System for determining the efficiency of publicity and/or broadcasted programs, comprising an audio signature generating unit with an adaptor that consists of a sampling unit for sampling the audio signal transmitted by the radio/TV at a first rate; a transformer, for obtaining galvanic separation between the power amplifier of the radio/TV, which feeds the loudspeakers and the input to the sampling circuitry. The audio signature generating unit is adapted to sample the audio signal transmitted by the receiver radio/TV that receives FM-radio/TV stations and to generate a characteristic audio signature. The system also comprises a plurality of stationary reference station units, each continuously listens to a station and is adapted to sample the audio signal transmitted by a particular broadcasting station to generate a stationary characteristic audio signature. A server is used to receive all signatures and continuously compare each characteristic audio signature to all stationary characteristic audio signatures, in order to find the best matching to one of the stationary characteristic audio signatures. If consecutive samples received from the audio signature generating unit appear essentially at the same timing within a predetermined time window, the server determines that the radio/TV receiver of a particular audio signature generating unit is currently tuned to a corresponding broadcasting station, for which the best matching has been found.

### FIELD OF THE INVENTION

This invention relates to a method and apparatus for determining the efficiency of publicity and/or broadcasted program. More particularly, the invention relates to a method and apparatus for determining the efficiency of publicity and/or broadcasted program for quickly identifying the radio/TV station to which a specific listener is locked, while listening to radio publicity and/or or watching TV broadcasted program.

### BACKGROUND OF THE INVENTION

Expenses for radio/TV publicity and/or program broadcasted constitute a high percentage of the costs which any manufacturing and/or selling company and/or TV or radio station have to bear in order to promote sales. It is of particular interest to all of said companies to know to what extent such publicity and/or broadcasted program is successful, and a very significant indication is given by the time during which various groups of possible consumers actually hear the publicity and/or broadcasted program. Among such groups are included drivers and passengers of cars, who hear the publicity and/or broadcasted radio program while traveling and keeping open the radio receiver (of which all cars are provided) or people watching TV at home.

All radio/TVs, at home or mounted in cars or being used indoor are provided with an antenna which may receive radio/TV signals from a number of broadcasting stations. Radio/TV signals are broadcast over specific frequencies, each defining a channel. To operate the radio/TV receiver, one has to tune it, viz. to choose the desired channel, separate it from other channels and extract the voice and/or music carried through said channel.

Publicity and/or broadcasted program transmitted by radio/TV are heard to a very considerable extent during travel by car or watching at home. Radio/TV transmissions are widely listened to by people at home or by drivers, whether professional or not, especially in rush hour time, on the way to work in the morning and on the way back home in the evening, so as to entertain them during journeys and reduce the danger that they may doze off. Since taxi drivers always keep their radio/TV in operation, passengers are also exposed to the radio/TV transmissions, whether they desire it or not. Therefore, an important slice of radio/TV publicity and/or broadcasted program is that which is sounded by car radio/TVs or.

It would be of considerable interest for companies which engage in publicity and/or broadcasted program to obtain in real time a significant index of the time during which said publicity and/or broadcasted program is heard, which on the average is an indication of the efficiency of said publicity and/or broadcasted program. However, the prior art does not include means for obtaining such an index in real time (by using the term “efficiency” it is meant to include any indication regarding the level of popularity of a radio or television program, as estimated by a poll of segments of the audience).

U.S. Pat. No. 7,809,324 discloses method and apparatus for determining the efficiency of publicity and/or broadcasted programs, according to which, when a TV converter or FM radio is operated, the frequency of the broadcast channel received at the moment is determined either directly from the TV converter or FM radio display or by extracting the LO frequency of the TV converter or FM radio. The frequency is transformed to a digital word and when the information as to the amount of watching and listening of a given publicity and/or broadcasted program or publicities is desired, a request for the information is sent and when received, the memorized digital words corresponding to the frequency of the broadcast channel received at the moment is transmitted. However, this system is incapable of detecting to which station the driver is listening, during time periods when different stations broadcast the same content and cannot determine whether or not the reception quality is reasonable.

The aforesaid prior art patents, and in general all the publications of the prior art, as far as it is known to the applicants, do not provide companies that carry out radio publicity and/or TV broadcasted program with the desired information using simple and inexpensive means, while maintaining the listeners' privacy.

More specifically, it is an object of this invention to provide a method and apparatus, applicable to a group of TV watchers and radio listeners who will agree to participate, that will permit to obtain reliable information as to the time during which specific publicity and/or broadcasted program is watched by TV watchers or heard by radio listeners, at home or in the car, whether drivers or passengers.

It is another object of this invention to obtain said information separately for specific broadcast channels.

It is a further object of the invention to obtain said information in real time.

It is a still further object of the invention to obtain said information by means of simple and inexpensive apparatus, which will not interfere with the normal operation of the TV converter or FM radio.

It is a still further object of the invention to provide a system and apparatus that will monitor all channels concurrently in real time, and not only a chosen one.

It is a still further purpose of the invention to provide a system and apparatus that will permit a very short timing of transmission and reception of signals relating to the desired information, and only by command.

It is a further object of this invention to provide such a system and apparatus that uses only licensed TV and radio channels dedicated and provided for such uses.

It is a still further object of the invention to provide such a system and apparatus that has no limits as to the detection zone or operation time and is not affected by parasitic leakage signals.

It is still further object of the invention to provide such a system not only for surveying TV and FM radio system but apply it to any other stationary radio/TV system generally used indoor, or any other mobile radio/TV system installed in any kind of vehicles, cars, airplanes or boats, which might include receiver only like in TV converter or FM radio/TV or transceiver for any kind of application, and can be AM, L-band, television sets, radar and so forth, either alone or in combination with the detection of FM stations. Moreover, the detected signal need not be LO signal generated by TV converter or FM radio/TV only, but can be any signal generated in the car in relation the other radio/TV system in use.

Other objects and advantages of the invention will appear as the description proceeds.

### SUMMARY OF THE INVENTION

The present invention is directed to a system for determining the efficiency of publicity and/or broadcasted programs, which comprises:

a) an audio signature generating unit having an adaptor, the adaptor consists of:
a.1) a sampling unit for sampling the audio signal transmitted by the radio/TV at a first rate;
a.2) a transformer, for obtaining galvanic separation between the power amplifier of the radio/TV, which feeds the loudspeakers and the input to the sampling circuitry,

the audio signature generating unit is adapted to sample the audio signal transmitted by the receiver radio/TV that receives FM-radio/TV stations and to generate a characteristic audio signature;

b) a plurality of stationary reference station units, each of which continuously listens to a station and is adapted to sample the audio signal transmitted by a particular broadcasting station to generate a stationary characteristic audio signature;

c) a server that is adapted to:
c.1) receive all signatures and continuously compares each characteristic audio signature to all stationary characteristic audio signatures, in order to find the best matching to one of the stationary characteristic audio signatures;
c.2) upon finding the best matching to a stationary characteristic audio signature, check if consecutive samples received from the audio signature generating unit appear essentially at the same timing within a predetermined time window;
c.3) if consecutive samples received from the audio signature generating unit appear essentially at the same timing within a predetermined time window, determine that the radio/TV receiver of a particular audio signature generating unit is currently tuned to a corresponding broadcasting station, for which the best matching has been found.

The reference station units may be FM-radio/TV stations or internet radio/TV stations and the broadcasting stations may be TV/video stations.

The audio signature generating unit may be an indoor unit or a vehicular unit installed in one or more of the following:
a car;
an airplane;
a boat.

The system may further comprise a processing center which is adapted to: receive the data regarding which radio stations or TV channels are listened to from the server;

processes the received data; and

displaying rating results for radio stations or TV channels.

Whenever the broadcasting station is an internet station, the characteristic audio signature may be generated using a reference station capture unit, which comprises:
a) an audio sampling unit for sampling the radio/ITV audio signal that corresponds to a current broadcasting station to an FM tuner of the radio/TV is tuned;
b) a processor with an internal buffer, for controlling the FM tuner to capture broadcasting stations, and for generating stationary characteristic audio signatures from the sampled audio signal;
c) a display for show the current received station;
d) a power supply unit for powering the audio sampling unit, the buffer and the processor; and
e) communication unit for transmitting the stationary characteristic audio signature to the server.

The FM tuner may be replaced by a Digital Video Broadcasting (DVB) receiver, for capturing broadcasting TV stations and detecting which station is broadcasting, using the audio data part.

The reference station capture unit may be adapted to:
a) establish communication with the server;
b) tune, by the processor, the FM tuner to a particular frequency that corresponds to a broadcasting station;
c) measure, by the processor, the strength of the received signal of the current broadcasting station, in order to determine the reception quality;
d) if the reception quality is found to be sufficient, update, by the processor, the display with the frequency of the current broadcasting station, and is not, tune the FM tuner to another frequency that corresponds to another broadcasting station;
e) re-tune the FM tuner to another frequency, until the reception quality of the new station is found to be sufficient;
f) sample the audio signals output from the FM tuner;
g) store the samples in a buffer, and as long as the buffer if not full, continue to store more samples;
h) calculate the power of the audio signal, to determine whether or not the FM tuner is operating;
i) calculate and generate reference audio signature from the stored samples, which includes a unique combination of spectral components;
j) send the signature along with audio power result to the server;
k) set a delay, which determines the spacing between subsequent samples of each reference station;
l) compare each characteristic audio signature received from each audio signature generating unit to a plurality of stationary reference stations, get optimal match.

Whenever the broadcasting station is an internet station, the reference station capture unit may be adapted to:
a) establish communication with the server;
b) connect to a particular internet broadcasting station, via an internet communication link;
c) receive an audio signal of the current internet broadcasting station;
d) check whether or not the link to the current internet broadcasting station is still active and if found to be active, decompress audio packets received via the internet communication link to the current broadcasting station and if not, at disconnect from internet communication link and connects to a link that corresponds to another broadcasting station;
e) repeat the process until the link to the new station is found to be active; and
f) check if the audio signal is a stereo signal and if it is, split the stereo signal to left and right channels and forward one of the channels to the sampling unit, otherwise,
g) convert the audio signal to a mono signal and forward it to the sampling unite.

On one aspect, the system comprises an adaptor for separating between the circuitry of the audio power amplifier that feeds the loudspeaker and the input to the sampling unit, the adaptor comprises a transformer for galvanic separation between the power amplifier of the radio/TV, which feeds the loudspeaker and the input to the sampling circuitry, wherein the primary of transformer is connected in parallel to the output of the power amplifier via a serial resistor, which limits the current that is sampled from the output of the power amplifier, and the secondary of transformer is connected the input to the sampling circuitry via an attenuator that is implemented by a parallel resistor and a serial capacitor, which limits the power of the audio signal that enters the sampling circuitry.

The present invention is also directed to a method for determining the efficiency of publicity and/or broadcasted programs, comprising the following steps:
a) storing samples from an audio signature generating unit for a preceding first time window;
b) storing samples from all reference units for a second and similar preceding time window;
c) shifting, by a processor, the first time window, relative to second time window, in steps of a predetermined time offset, until reaching a minimal overlap between windows;
d) for each step of time offset, assigning, by the processor, a quality index for the level of match between samples stored in the two buffers by comparing signatures that correspond to an audio signature generating unit to signatures that correspond to all reference units;
e) storing, by the processor, the best match quality index over all reference units, for each sample received from the audio signature generating unit, along with its corresponding time offset;
f) checking, by the processor, if the current time offset that corresponds to the best match quality index of each sample received from the audio signature generating unit, is similar to the preceding time offset that yielded the best match quality index for that sample; and
g) if it is similar, and if the match quality index is sufficient, determining, by the processor, that the audio signature generating unit is locked to the station to which the samples from the audio signature generating unit belong.

The processor determines to which broadcasting station the audio signature generating unit is locked by the following steps:
a) sampling the audio signal of each audio signature generating unit at a relatively low sampling rate and the reference stations at much higher rate;
b) storing in a buffer, all samples of all reference stations over a predetermined time window relative to the sampling time of the audio signal in the audio signature generating unit; and
c) comparing each sample from the audio signature generating unit to all samples from all reference stations, over the entire time window, to detect a point of maximum correlation between samples signatures.

The optimal match between signatures may be found by:
a) sampling from audio signature generating unit are stored for a preceding time window;
b) storing samples from all reference units are for a similar preceding time window;
c) shifting the first time window, relative to second time window, in steps of a predetermined time offset, until reaching a minimal overlap between windows;
d) assigning a quality index for the level of match between samples stored in the two buffers for each step of time offset, by comparing signatures that correspond to an audio signature generating unit to signatures that correspond to all reference units;
e) storing the best match quality index over all reference units for each sample received from the audio signature generating unit, along with its corresponding time offset;
f) checking if the current time offset that corresponds to the best match quality index of each sample received from the audio signature generating unit is similar to the preceding time offset that yielded the best match quality index for that sample; and
g) if it is similar, and if the match quality index is sufficient, determining that the audio signature generating unit is locked to the station to which the samples from the audio signature generating unit belong.

### BRIEF DESCRIPTION OF THE DRAWINGS

In the drawings:

FIG. 1 illustrates a block diagram of a the audio signature generating unit, according to an embodiment of the invention;

FIG. 2 is a flowchart of the operations performed by the audio signature generating unit;

FIG. 3a is a block diagram of a possible reference station capture unit, according to an embodiment of the invention;

FIG. 3b is a block diagram of a possible reference station capture unit, according to another embodiment of the invention;

FIG. 4 is a flowchart of the operations performed by reference station capture unit;

FIG. 5 is a flowchart of the operations performed by reference station capture unit, in case where the broadcasting station is an internet station;

FIG. 6 is a flowchart of the operations performed by reference station capture unit, in case where the broadcasting station is an internet station;

FIG. 7 is a schematic illustration of an adaptor, for separating between the circuitry of the audio power amplifier that feeds the loudspeaker and the input to the sampling unit, according to an embodiment of the invention;

FIG. 8 is a flowchart illustrating the process of finding the optimal match between signatures; and

FIG. 9 schematically indicates the processing of the data provided by the apparatus of the invention.

### DETAILED DESCRIPTION OF PREFERRED EMBODIMENTS

The system proposed by the present invention includes an audio signature generating unit having a radio/TV receiver, which is installed in a public vehicle or a private vehicle of a user (listener) or at his home and a plurality of stationary reference station units, each of which continuously listens to a radio station or a TV channel. Each audio signature generating unit samples the audio signal transmitted by the radio/TV and generates a unique characteristic audio signature. Similarly, each reference station unit samples the audio signal transmitted (using radio/TV signals or via the internet) by a particular broadcasting radio/TV station and generates a stationary (i.e., belonging to a station) corresponding characteristic audio signature for that broadcasting station. A server, which is tuned to concurrently receive all stations in real-time, receives all signatures and continuously compares each characteristic audio signature to all stationary characteristic audio signatures, in order to find the best matching to one of the stationary characteristic audio signatures. Upon finding the best matching, the server determined that the radio/ITV receiver of a particular audio signature generating unit is currently tuned (by the user) to a corresponding broadcasting station, for which best matching has been found.

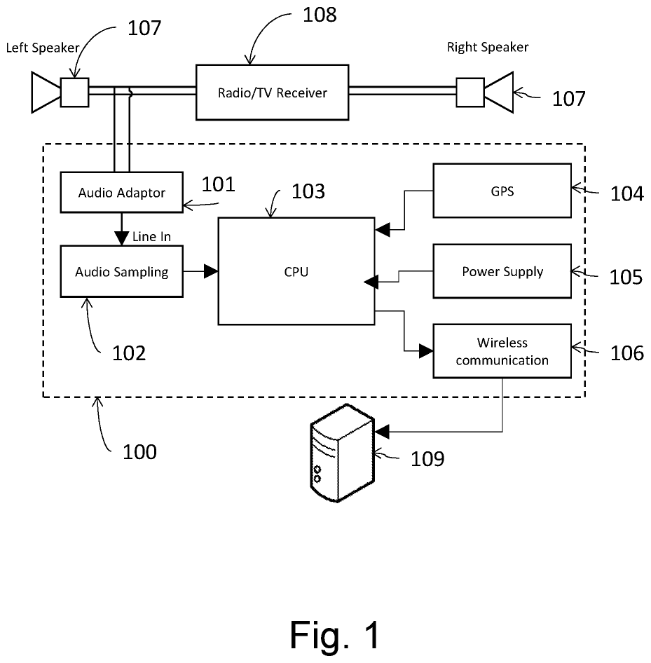

FIG. 1 illustrates a block diagram of an audio signature generating unit 100, according to an embodiment of the invention. The audio signature generating unit 100 includes an audio adaptor 101, an audio sampling unit 102, a processor 103 with an internal buffer, a GPS receiver 104, a power supply unit 105 and a wireless communication unit 106. Adaptor 101 is connected to one of the loudspeakers 107 of the radio/TV receiver 108 on one side and to audio sampling unit 102 on the other side, and matches between the impedances of the audio power amplifier that feeds the loudspeaker. Audio sampling unit 102 samples the radio/TV audio signal that corresponds to a current broadcasting station, and forwards them to processor 103, which generates the characteristic audio signature from the sampled audio signal.

Processor 103 also receives location data from GPS receiver 104, in order to know at a later stage, at which frequency the received radio/TV station transmits (since the same station may transmit at different frequencies at different geographical locations). Power supply unit 105 feeds DC power to all components of audio signature generating unit 100. A wireless communication unit 106 is used to transmit the characteristic audio signature to a remote server 109, along with the location data.

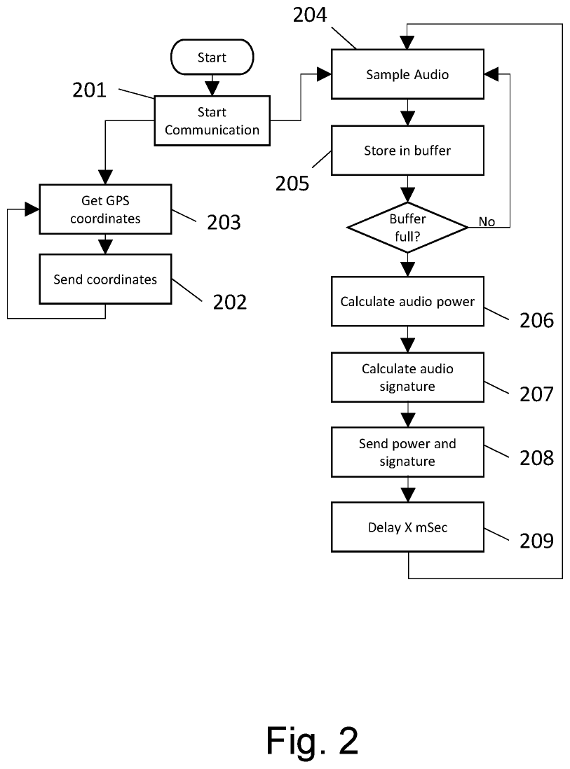

FIG. 2 is a flowchart of the operations performed by audio signature generating unit 100. At the first step 201, communication is established between the audio signature generating unit and the radio/TV. At the next step 202, GPS unit 104 outputs the current location coordinates of the audio signature generating unit. At the next step 203, processor 103 receives the current location coordinates. At the next step 204, sampling unit 102 samples the audio signals output from the radio/TV receiver. At the next step 205, processor 103 stores the samples in a buffer, and as long as the buffer if not full, continues to store more samples. At the next step 206, processor 103 calculates the power of the audio signal, to determine whether or not the radio/TV receiver is operating. At the next step 207, processor 103 calculates and generates an audio signature from the stored samples, which includes a unique combination of spectral components. At the next step 208, processor 103 sends the signature along with audio power result to remote server 109. At the next step 209, processor 103 sets a delay, which determines the spacing between subsequent samples.

At the server side, the server 109 is tuned to receive all stations in real-time and there is a plurality of stationary reference stations, which are used to generate parallel audio signatures, to which characteristic audio signatures received from each audio signature generating unit 100 are compared.

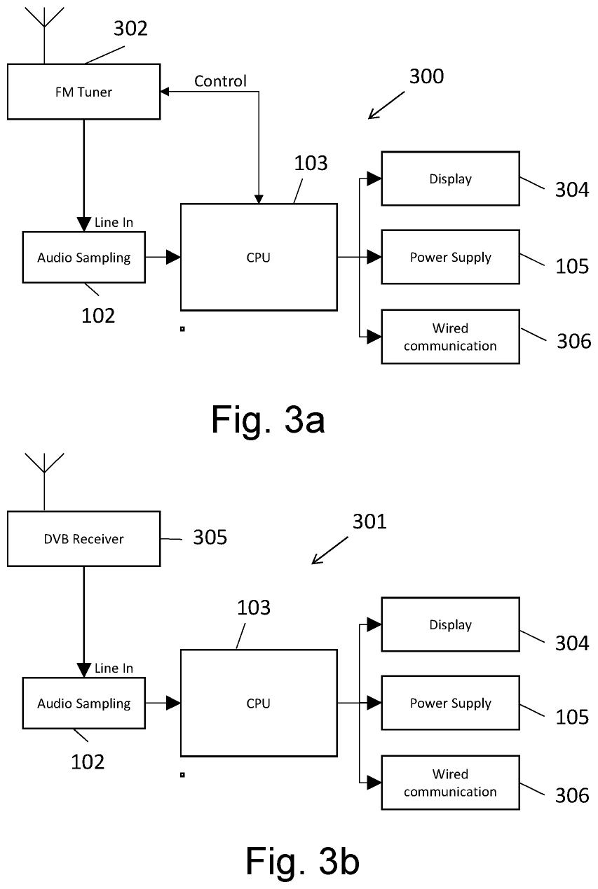

FIG. 3a is a block diagram of a possible reference station capture unit 300, according to an embodiment of the invention. The reference unit 300 includes an audio sampling unit 102, a processor 103 with an internal buffer, a display 304 to show the current received station, a power supply unit 105 and a wired communication unit 306. FM tuner 302 is controlled by processor 103, in order to capture broadcasting stations. Audio sampling unit 102 samples the radio/TV audio signal that corresponds to a current broadcasting station to which FM tuner 302 is tuned and forwards them to processor 103, which generates stationary characteristic audio signatures from the sampled audio signal.

Power supply unit 105 feeds DC power to all components of reference station capture unit 300. A wired communication unit 306 is used to transmit the stationary characteristic audio signature to remote server 109. FIG. 3b is a block diagram of a possible reference station capture unit 301, according to another embodiment of the invention. In this embodiment, the reference unit 301 includes the same components as reference station capture unit 300, except for the FM tuner which is replaced by a Digital Video Broadcasting (DVB) receiver 305, in order to capture broadcasting TV stations and detect which station is broadcasting, using the audio data part.

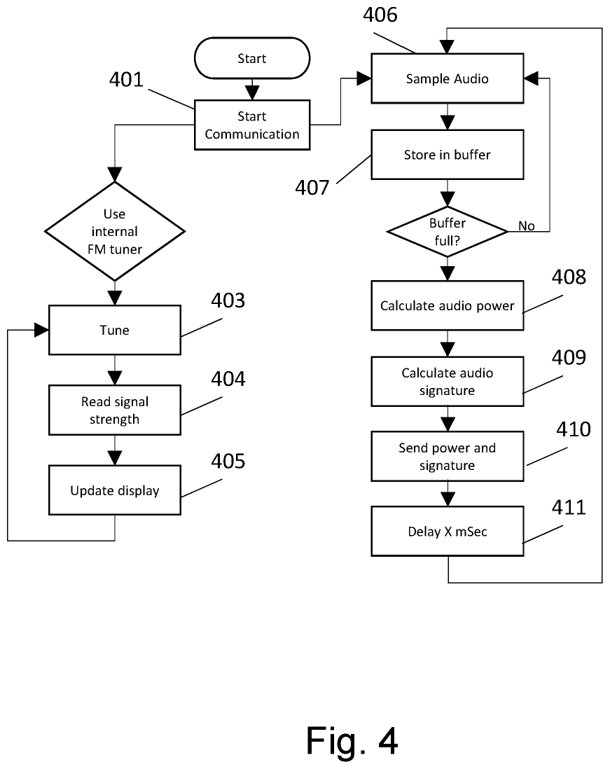

FIG. 4 is a flowchart of the operations performed by reference station capture unit 300. At the first step 401, communication is established between the unit 300 and the server 109. At the next step 403, processor 103 tunes the FM tuner 302 to a particular frequency that corresponds to a broadcasting station. At the next step 404, processor 103 measures the strength of the received signal (of the current broadcasting station), in order to determine the reception quality. If the reception quality is found to be sufficient, at the next step 405 processor 103 updates the display 304 with the frequency of the current broadcasting station. If not, processor 103 tunes the FM tuner 302 to another frequency that corresponds to another broadcasting station. The process is repeated, until the reception quality of the new station is found to be sufficient. At the next step 406, sampling unit 102 samples the audio signals output from the FM tuner 302. At the next step 407, processor 103 stores the samples in a buffer, and as long as the buffer if not full, continues to store more samples. At the next step 408, processor 103 calculates the power of the audio signal, to determine whether or not the FM tuner is operating. At the next step 409, processor 103 calculates and generates reference audio signature from the stored samples, which includes a unique combination of spectral components. At the next step 410, processor 103 sends the signature along with audio power result to remote server 109. At the next step 411, processor 103 sets a delay, which determines the spacing between subsequent samples of each reference station. Here again, server 109 compares each characteristic audio signature received from each audio signature generating unit 100 to a plurality of stationary reference stations, so as to get optimal match.

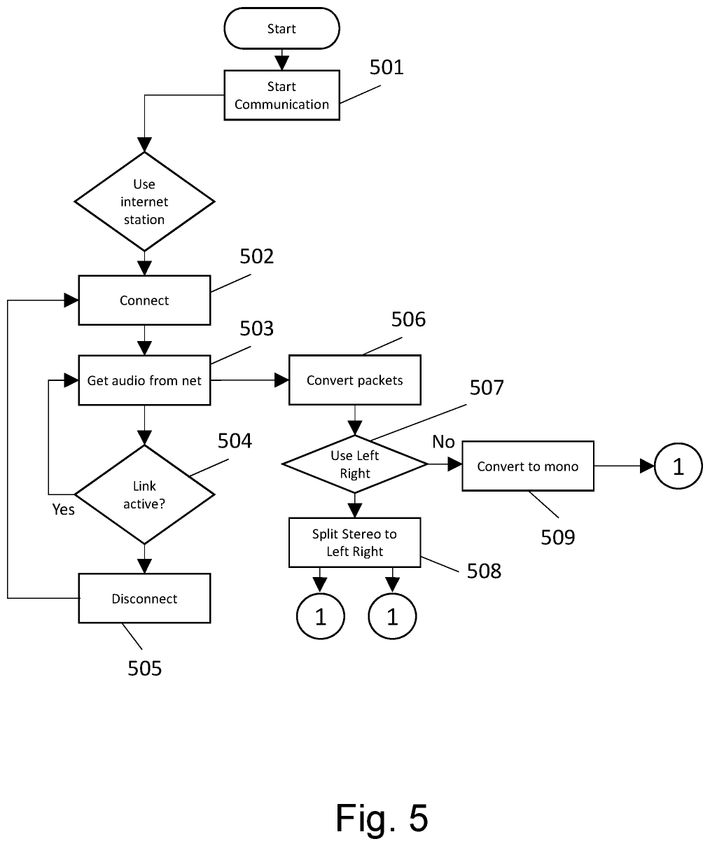

FIG. 5 is a flowchart of the operations performed by reference station capture unit 300, in case where the broadcasting station is an internet station. At the first step 501, communication is established between the unit 300 and the server 109. At the next step 502, processor 103 connects to a particular internet broadcasting station, via an internet communication link. At the next step 503, processor 103 receives an audio signal (of the current internet broadcasting station). At the next step 504, processor 103 checks whether or not the link to the current internet broadcasting station is still active. If found to be active, at the next step 506 processor 103 decompresses audio packets received via the internet communication link to the current broadcasting station. If not, at step 505 processor 103 disconnects from internet communication link and connects to a link that corresponds to another broadcasting station and the process is repeated, until the link to the new station is found to be active. At the next step 507, processor 103 checks if the audio signal is a stereo signal. If it is, at the next step 508, processor 103 splits the stereo signal to left and right channels and forwards one of the channels to sampling unit 102, for further processing as described with respect to FIGS. 1 and 2 above. If not, processor 103 converts the audio signal to a mono signal and forwards it to sampling unit 102, for further processing as described with respect to FIGS. 1 and 2 above.

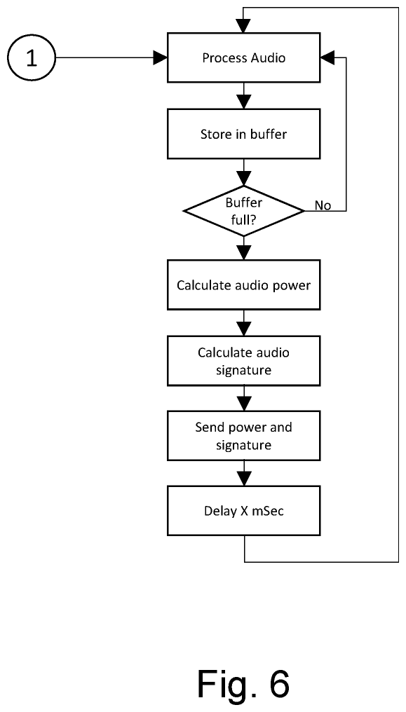

FIG. 6 is a flowchart of the operations performed by reference station capture unit 300, in case where the broadcasting station is an internet station. In this case, the process is similar to the process described with respect to FIG. 4 above.

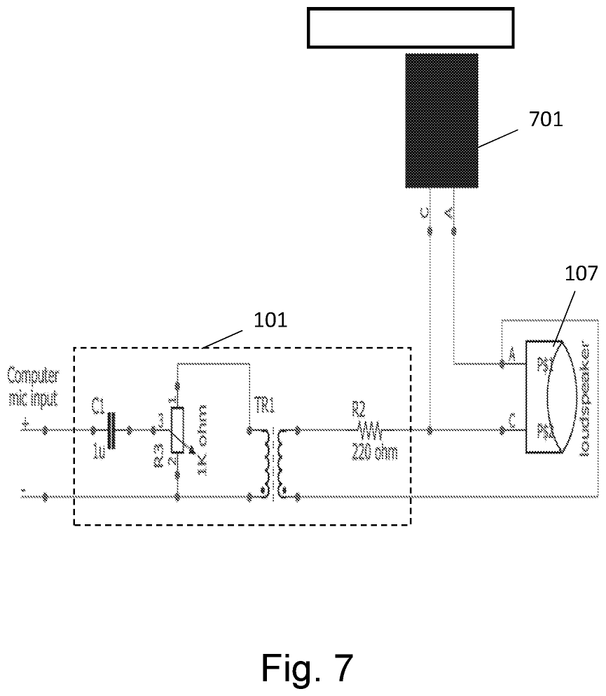

FIG. 7 is a schematic illustration of an adaptor, for separating between the circuitry of the audio power amplifier that feeds the loudspeaker and the input to the sampling unit, according to an embodiment of the invention. Adaptor 101 consists of a transformer TR1, for galvanic separation between power amplifier 701 of the radio/TV, which feeds loudspeaker 107 and the input to the sampling circuitry (generally the microphone input of a computer). The primary of transformer TR1 is connected in parallel to the output of power amplifier 701 via a serial resistor R2 (about 220Ω), which limits the current that is sampled from the output of power amplifier 701. The secondary of transformer TR1 is connected the input to the sampling circuitry via an attenuator that is implemented by a parallel resistor R3 (about 1 KΩ) and a serial capacitor C1 (about 1 μF), which limits the power of the audio signal that enters the sampling circuitry.

Determining to which Broadcasting Station the Audio Signature Generating Unit is Locked

The system proposed by the present invention is capable of determining to which broadcasting station the audio signature generating unit 100 is locked, by a process that checks correlation of both the timing and signature received from each audio signature generating unit 100 and signatures received from stationary reference stations. Such correlation is required, since for the same broadcasting station, there is a difference between the timing of audio information received by the car radio/TV and audio information received by a reference station. Such a difference exists, since FM-radio/TV transmission of a particular station is not synchronized to the transmission of the same station over the internet. In addition, there are further delaying factors, such as the delay introduced by the transmitting server, etc. As a result, there may be a time offset between samples of the audio signal originated from the audio signature generating unit 100 and samples of the same audio signal originated from the corresponding reference station.

These problems are overcome by the system proposed by the present invention by sampling the audio signal of each audio signature generating unit 100 at a relatively low sampling rate (typically twice a second) and sampling the reference stations at much higher rate (typically 100 times each second) and storing all samples of all reference stations over a predetermined time window (relative to the sampling time of the audio signal in the audio signature generating unit 100) of about ±60 Sec, in a buffer. As a result, there are many samples of reference stations, to which each signature from the audio signature generating unit 100 is compared. This substantially increases the probability that there will be a sample of a reference station at the same timing. In fact, the server 109 compares each sample from the audio signature generating unit 100 to all samples from all reference stations, over the entire time window, in order to detect a point of maximum correlation between samples signatures. Detecting such correlation increases the probability that the audio signature generating unit 100 is locked to the station for which this probability was the highest.

On the other hand, sometimes different broadcasting stations transmit the same audio information during predetermined time periods and therefore, it is more difficult to determine to which station the audio signature generating unit 100 is locked. For example, Station A and Station B can simultaneously broadcast the same newscast. In this case, it will be impossible to determine to which station audio signature generating unit 100 is locked during the newscast, since the level of correlation between signatures will be the same. This problem is also overcome by the system proposed by the present invention, by check-in the timing of samples within the predetermined time window. For example, if the car radio/TV it tuned to Station A and at the server side, both Station A and Station B are sampled. Server 109 compares the signature of Station A to all signatures of all reference stations and detects correlation only to Station A at time point of +10 Sec (within a predetermined window of ±60 Sec). As soon as receiving the next sample's signature from the audio signature generating unit 100, it is likely to appear essentially at the same time point of +10 Sec. This way, even if the level of correlation for Station B will be higher than for Station A, server 109 will determine that the audio signature generating unit 100 is locked to Station A, as appearing at the same timing within the window.

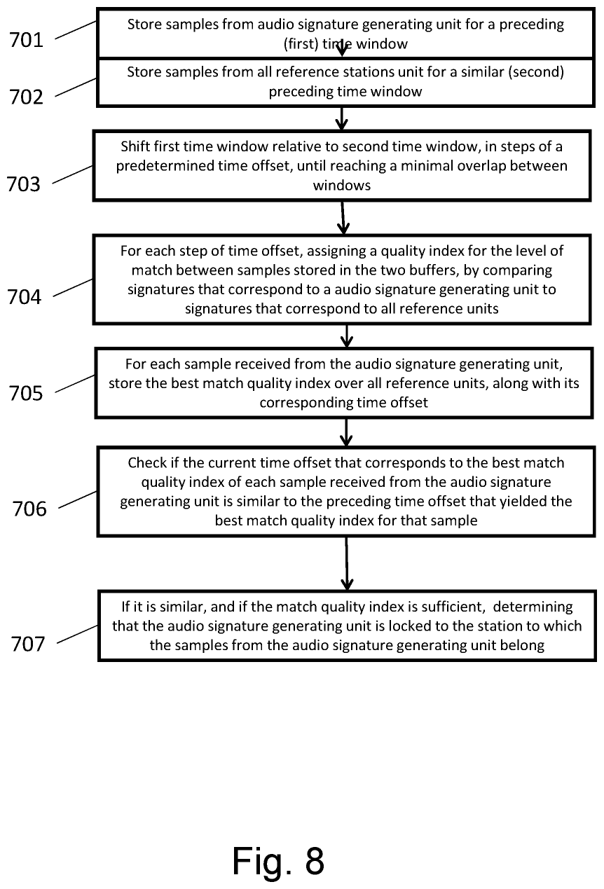

FIG. 8 is a flowchart illustrating the process of finding the optimal match between signatures. At the first step 701, samples from audio signature generating unit 100 are stored for a preceding (first) time window (e.g., 70 Sec, which correspond to the maximum delay between the FM radio/TV signal received by the audio signature generating unit and the signals received from the corresponding reference internet station). At the next step 702, samples from all reference units are stored for a similar (second) preceding time window.

At the next step 703, the first time window is shifted, relative to second time window, in steps of a predetermined time offset, until reaching a minimal overlap between windows. At the next step 704, a quality index for the level of match between samples stored in the two buffers is assigned for each step of time offset, by comparing signatures that correspond to an audio signature generating unit 100 to signatures that correspond to all reference units. At the next step 705, the best match quality index over all reference units is stored for each sample received from the audio signature generating unit 100, along with its corresponding time offset. At the next step 706, the system checks if the current time offset that corresponds to the best match quality index of each sample received from the audio signature generating unit 100, is similar to the preceding time offset that yielded the best match quality index for that sample. At the next step 707, if it is similar, and if the match quality index is sufficient, the system determines that the audio signature generating unit 100 is locked to the station to which the samples from the audio signature generating unit 100 belong.

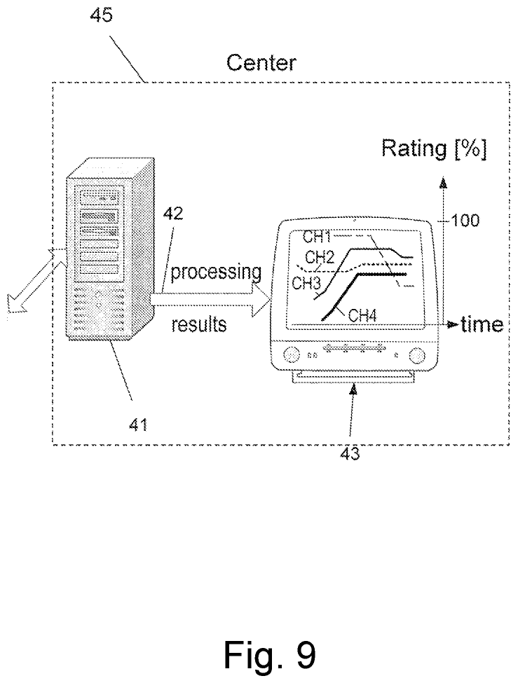

FIG. 9 schematically indicates the processing of the data provided by the apparatus of the invention. Server 109 provides the data collected to a processing center, generally indicated at 45, which includes a processing server 41 which receives the data and processes it according to a program that is formulated by a skilled programmer as required in each case and need not be discussed herein. In this embodiment, the results are transferred at 42 to a display 43. The various publicity and/or broadcasted program, that are found to have been listened to, are plotted against time and the resulting curves permit to attribute to each of them a level of rating. The graphic display might be lacking and the data may be processed digitally. Processing center 45 may be adapted to display ratings for different radio stations and TV channels, according to data taken from all listeners, to a part of them (using for example, queries and sample groups).

The above embodiments have been described by way of illustration only and it will be understood that the invention may be carried out with many variations, modifications and adaptations, without departing from its spirit or exceeding the scope of the claims.

1. System for determining the efficiency of publicity and/or broadcasted programs, comprising:
a) an audio signature generating unit having an adaptor, said adaptor consists of:
a.1) a sampling unit for sampling the audio signal transmitted by the radio/TV at a first rate;
a.2) a transformer, for obtaining galvanic separation between the power amplifier of the radio/TV, which feeds the loudspeakers and the input to said sampling circuitry,
said audio signature generating unit is adapted to sample the audio signal transmitted by the receiver radio/TV that receives FM-radio/TV stations and to generate a characteristic audio signature;
b) a plurality of stationary reference station units, each of which continuously listens to a station and is adapted to sample the audio signal transmitted by a particular broadcasting station to generate a stationary characteristic audio signature;
c) a server that is adapted to:
c.1) receive all signatures and continuously compares each characteristic audio signature to all stationary characteristic audio signatures, in order to find the best matching to one of the stationary characteristic audio signatures;
c.2) upon finding the best matching to a stationary characteristic audio signature, check if consecutive samples received from said audio signature generating unit appear essentially at the same timing within a predetermined time window;
c.3) if consecutive samples received from said audio signature generating unit appear essentially at the same timing within a predetermined time window, determine that the radio/TV receiver of a particular audio signature generating unit is currently tuned to a corresponding broadcasting station, for which the best matching has been found.

2. System according to claim 1, in which the reference station units are FM-radio/TV stations.

3. System according to claim 1, in which the reference station units are internet radio/TV stations.

4. System according to claim 1, in which the broadcasting stations are TV/video stations.

5. System according to claim 1, in which the audio signature generating unit is a vehicular unit installed in one or more of the following:
a car;
an airplane;
a boat.

6. System according to claim 1, in which the audio signature generating unit is an indoor unit.

7. System according to claim 1, further comprising a processing center which is adapted to:
receive the data regarding which radio stations or TV channels are listened to from the server;
processes the received data; and
displaying rating results for radio stations or TV channels.

8. System according to claim 1, in which whenever the broadcasting station is an internet station, the characteristic audio signature is generated using a reference station capture unit, which comprises:
a) an audio sampling unit for sampling the radio/TV audio signal that corresponds to a current broadcasting station to an FM tuner of said radio/TV is tuned;
b) a processor with an internal buffer, for controlling said FM tuner to capture broadcasting stations, and for generating stationary characteristic audio signatures from the sampled audio signal;
c) a display for show the current received station;
d) a power supply unit for powering said audio sampling unit, said buffer and said processor; and
e) communication unit for transmitting said stationary characteristic audio signature to the server.

9. System according to claim 8, in which FM tuner is replaced by a Digital Video Broadcasting (DVB) receiver, for capturing broadcasting TV stations and detecting which station is broadcasting, using the audio data part.

10. System according to claim 8, in which the reference station capture unit is adapted to:
a) establish communication with the server;
b) tune, by the processor, the FM tuner to a particular frequency that corresponds to a broadcasting station;
c) measure, by the processor, the strength of the received signal of the current broadcasting station, in order to determine the reception quality;
d) if the reception quality is found to be sufficient, update, by the processor, the display with the frequency of the current broadcasting station, and is not, tune the FM tuner to another frequency that corresponds to another broadcasting station;
e) re-tune the FM tuner to another frequency, until the reception quality of the new station is found to be sufficient:
f) sample the audio signals output from the FM tuner;
g) store the samples in a buffer, and as long as the buffer if not full, continue to store more samples;
h) calculate the power of the audio signal, to determine whether or not the FM tuner is operating;
i) calculate and generate reference audio signature from the stored samples, which includes a unique combination of spectral components;
j) send the signature along with audio power result to the server;
k) set a delay, which determines the spacing between subsequent samples of each reference station;
l) compare each characteristic audio signature received from each audio signature generating unit to a plurality of stationary reference stations, get optimal match.

11. System according to claim 8, in which whenever the broadcasting station is an internet station, the reference station capture unit is adapted to:
a) establish communication with the server;
b) connect to a particular internet broadcasting station, via an internet communication link;
c) receive an audio signal of the current internet broadcasting station;
d) check whether or not the link to the current internet broadcasting station is still active and if found to be active, decompress audio packets received via the internet communication link to the current broadcasting station and if not, at disconnect from internet communication link and connects to a link that corresponds to another broadcasting station;
e) repeat the process until the link to the new station is found to be active; and
f) check if the audio signal is a stereo signal and if it is, split the stereo signal to left and right channels and forward one of the channels to the sampling unit, otherwise,
g) convert the audio signal to a mono signal and forward it to the sampling unite.

12. System according to claim 1, comprising an adaptor for separating between the circuitry of the audio power amplifier that feeds the loudspeaker and the input to the sampling unit, said adaptor comprises a transformer for galvanic separation between the power amplifier of the radio/TV, which feeds the loudspeaker and the input to the sampling circuitry, wherein the primary of transformer is connected in parallel to the output of said power amplifier via a serial resistor, which limits the current that is sampled from the output of said power amplifier, and the secondary of transformer is connected the input to the sampling circuitry via an attenuator that is implemented by a parallel resistor and a serial capacitor, which limits the power of the audio signal that enters the sampling circuitry.

13. Method for determining the efficiency of publicity and/or broadcasted programs, comprising:
a) storing samples from an audio signature generating unit for a preceding first time window;
b) storing samples from all reference units for a second and similar preceding time window;
c) shifting, by a processor, the first time window, relative to second time window, in steps of a predetermined time offset, until reaching a minimal overlap between windows;
d) for each step of time offset, assigning, by said processor, a quality index for the level of match between samples stored in the two buffers by comparing signatures that correspond to an audio signature generating unit to signatures that correspond to all reference units;
e) storing, by said processor, the best match quality index over all reference units, for each sample received from the audio signature generating unit, along with its corresponding time offset;
f) checking, by said processor, if the current time offset that corresponds to the best match quality index of each sample received from the audio signature generating unit, is similar to the preceding time offset that yielded the best match quality index for that sample; and
g) if it is similar, and if the match quality index is sufficient, determining, by said processor, that the audio signature generating unit is locked to the station to which the samples from the audio signature generating unit belong.

14. Method according to claim 13, wherein the processor determines to which broadcasting station the audio signature generating unit is locked by the following steps:
a) sampling the audio signal of each audio signature generating unit at a relatively low sampling rate and the reference stations at much higher rate;
b) storing in a buffer, all samples of all reference stations over a predetermined time window relative to the sampling time of the audio signal in the audio signature generating unit; and
c) comparing each sample from the audio signature generating unit to all samples from all reference stations, over the entire time window, to detect a point of maximum correlation between samples signatures.

15. Method according to claim 13, wherein the optimal match between signatures is found by:
a) sampling from audio signature generating unit are stored for a preceding time window;
b) storing samples from all reference units are for a similar preceding time window;
c) shifting the first time window, relative to second time window, in steps of a predetermined time offset, until reaching a minimal overlap between windows;
d) assigning a quality index for the level of match between samples stored in the two buffers for each step of time offset, by comparing signatures that correspond to an audio signature generating unit to signatures that correspond to all reference units;
e) storing the best match quality index over all reference units for each sample received from the audio signature generating unit, along with its corresponding time offset;
f) checking if the current time offset that corresponds to the best match quality index of each sample received from the audio signature generating unit is similar to the preceding time offset that yielded the best match quality index for that sample; and
g) if it is similar, and if the match quality index is sufficient, determining that the audio signature generating unit is locked to the station to which the samples from the audio signature generating unit belong.
